(19) United States
(12) Patent Application Publication
(10) Pub. No.: US 2022/0291876 A1
(43) Pub. Date: Sep. 15, 2022

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Katsunori SUZUKI, Mishima (JP)

(73) Assignee: TOSHIBA TEC KABUSHIKI KAISHA, Tokyo (JP)

(21) Appl. No.: 17/196,353

(22) Filed: Mar. 9, 2021

(51) Int. Cl. G06F 3/12; H04N 1/00

(52) U.S. Cl. CPC G06F 3/121; H04N 1/00029; H04N 1/00039; G06F 3/1234

(57) ABSTRACT

According to one embodiment, there is provided an information processing apparatus including a controller. The controller is configured to acquire abnormality prediction information relating to a predicted abnormality concerning operation of the information processing apparatus. The controller is configured to generate equipment information based on the abnormality prediction information acquired by the controller. The controller is configured to output the equipment information generated by the controller.

### FIELD

Embodiments described herein relate generally to an information processing apparatus and an information processing method.

### BACKGROUND

A technique of using a smartphone application to select a digital multifunction peripheral (MFP) to be utilized and to utilize a function of a printer or scanner is known. The smartphone user can select the MFP to be utilized based on information on usable MFPs listed in the application.

In this case, information on the MFP that cannot be utilized due to a failure or the like is not displayed, but information on the MFP that is abnormal but does not lead to the failure is displayed. For that reason, an error such as a jam may occur in the MFP selected by the user, which is not convenient.

### DESCRIPTION OF THE DRAWINGS

FIG. 1 is a block diagram illustrating an information processing system according to an embodiment;

FIG. 2 is a diagram illustrating an outline of a configuration example of an image forming apparatus according to an embodiment;

FIG. 3 is a block diagram illustrating the outline of the configuration example of the image forming apparatus;

FIG. 4 is a diagram illustrating an example of an equipment list displayed on a user terminal according to an embodiment;

FIG. 5 is a diagram illustrating abnormality prediction information and equipment information in the image forming apparatus;

FIG. 6 is a diagram illustrating an example of a combination of the abnormality prediction information and the equipment information in the image forming apparatus; and

FIG. 7 is a flowchart illustrating a processing procedure for generating equipment information in the image forming apparatus.

### DETAILED DESCRIPTION

In general, according to one embodiment, there is provided an information processing apparatus including a controller. The controller is configured to acquire abnormality prediction information relating to a predicted abnormality concerning operation of the information processing apparatus. The controller is configured to generate equipment information based on the abnormality prediction information acquired by the controller. The controller is configured to output the equipment information generated by the controller.

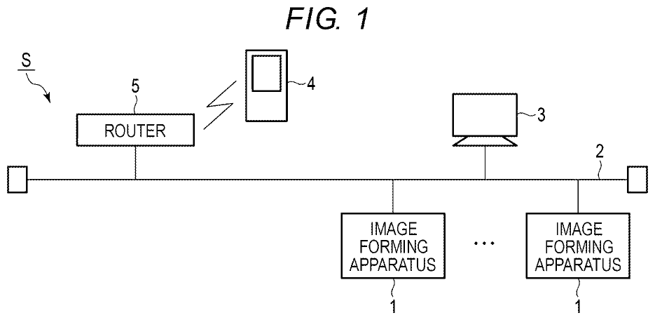

Hereinafter, embodiments will be described with reference to the accompanying drawings. FIG. 1 is a block diagram illustrating an information processing system S according to an embodiment. The information processing system S includes at least one image forming apparatus 1, an administrator terminal 3, a user terminal 4, and a router 5. The information processing system S includes a network 2, and each image forming apparatus 1, the administrator terminal 3, and the router 5 are connected to the network 2 to construct a system. The network 2 is typically a local area network (LAN). The LAN may be wired or wireless. Each of the image forming apparatus 1 and the administrator terminal 3 can be connected to the user terminal 4 through the router 5. The information processing system S may also refer to a system including at least two of the image forming apparatus 1, the administrator terminal 3, and the user terminal 4. The image forming apparatus 1 is sometimes referred to as equipment. The image forming apparatus 1 is an example of an information processing apparatus.

The image forming apparatus 1 is an apparatus having an electrophotographic printing function. In this embodiment, the image forming apparatus 1 will be described as being a digital multifunction peripheral (MFP) having a copy function, a print function, a facsimile function, a scanner function, and the like. A configuration example of the image forming apparatus 1 will be described later.

The administrator terminal 3 is equipment capable of communicating with other pieces of equipment. The administrator terminal 3 is, for example, equipment used by an administrator of an office, a factory, or the like. For example, the administrator terminal 3 is a smartphone, a tablet terminal, a personal computer (PC), or the like. The administrator terminal 3 communicates with the image forming apparatus 1 and a management server (not illustrated) according to various information received from the image forming apparatus 1. For example, the administrator terminal 3 outputs a maintenance request notification, which will be described later, to the management server via the Internet. The management server communicates with equipment used by a serviceman who performs maintenance work on the image forming apparatus 1 in response to the maintenance request notification received from the administrator terminal 3. The maintenance work includes work such as repair and maintenance of each part of the image forming apparatus 1.

The user terminal 4 (e.g., a user device) is equipment capable of communicating with other pieces of equipment. The user terminal 4 is equipment owned by the user. For example, the user terminal 4 is a smartphone, a tablet terminal, or the like. The user terminal 4 communicates with the image forming apparatus 1 in response to start of the application correlated with the image forming apparatus 1 by the user. The user may be read as an operator or a person.

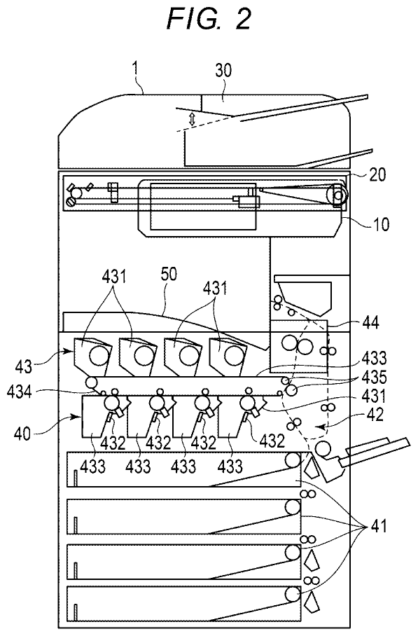

FIG. 2 is a diagram illustrating an outline of a configuration example of the image forming apparatus 1. The image forming apparatus 1 includes a control panel 10, a scanner unit 20, an automatic document feeding apparatus 30, a printer unit 40, and a paper discharge tray 50.

The control panel 10 (e.g., a user interface) includes a display device that displays various screens. The control panel 10 includes an input device for inputting an instruction based on an operation of an operator. The control panel 10 includes lamps that are lit in various colors. Lighting may include blinking. The control panel 10 includes a speaker that outputs voice.

The scanner unit (scanner) 20 is an apparatus that reads an image from a medium such as a document. For example, the medium is paper, but is not limited thereto. The scanner unit 20 includes a line sensor. As the line sensor, a charge coupled device (CCD) line sensor may be adopted. As the line sensor, a contact image sensor (CIS) may be adopted. The line sensor may adopt a sensor other than these. The scanner unit 20 generates image data based on an image read by using the line sensor.

The automatic document feeding apparatus (document feeder) 30 is an apparatus that conveys a medium such as a document to a reading position of the scanner unit 20. The automatic document feeding apparatus 30 includes a tray on which a medium is placed. The automatic document feeding apparatus 30 conveys the medium placed on the tray to the reading position of the scanner unit 20 one after another. The automatic document feeding apparatus 30 is also referred to as an automatic document feeder (ADF).

The printer unit (printer) 40 is an apparatus that forms an image on the medium by fixing a toner image transferred to the medium. The printer unit 40 may form the image on the medium based on the image data generated by the scanner unit 20. The printer unit 40 may form the image on the medium based on image data received by the image forming apparatus 1 from another apparatus.

The paper discharge tray 50 is a tray on which a medium, which is discharged from the printer unit 40 and on which an image is formed by the printer unit 40, is placed.

The printer unit 40 includes an accommodation unit 41, a conveyance unit 42, an image forming unit 43, and a fixing unit 44.

The accommodation unit 41 (e.g, a paper storage assembly, a paper feeing assembly, etc.) is an element that accommodates the medium. The accommodation unit 41 includes a plurality of paper feed cassettes. Each paper feed cassette accommodates a medium of a predetermined size and type. Each paper feed cassette includes a pickup roller. The pickup roller picks up the media one by one from the paper feed cassette. The pickup roller supplies the picked-up medium to the conveyance unit 42.

The conveyance unit 42 includes a plurality of rollers, a plurality of convey guides, and the like for conveying the medium in the image forming apparatus 1. The conveyance unit 42 conveys the medium supplied from the accommodation unit 41 in the order of the image forming unit 43 and the fixing unit 44. The conveyance unit 42 conveys the medium, on which the image is formed and which is passed through the fixing unit 44, to the paper discharge tray 50.

The image forming unit 43 is an element that forms a toner image on the medium. The image forming unit 43 includes a plurality of toner cartridges 431, a plurality of developing units 432, a plurality of exposure devices 433, an intermediate transfer belt 434, and a transfer unit 435.

Each of the plurality of toner cartridges 431 (e.g., developer containers) is an element that stores the toner (e.g., as part of a two part developer). The plurality of toner cartridges 431 are a plurality of toner cartridges that store toner of a color. The plurality of toner cartridges 431 include a cyan toner cartridge, a magenta toner cartridge, a yellow toner cartridge, and a black toner cartridge. The plurality of toner cartridges 431 may include toner cartridges of decolorable toner that is decolored at a temperature higher than a predetermined temperature. Each toner cartridge 431 supplies the toner to each developing unit 432. When the image forming apparatus 1 is an apparatus for forming an image on a medium in a single color, the image forming unit 43 is configured to include one toner cartridge 431 instead of a plurality of the toner cartridges.

Each of the plurality of developing units 432 is an element that performs multiple transfer of the toner image of a color on a surface of the intermediate transfer belt 434. The plurality of developing units 432 are a plurality of developing units corresponding to toner of a color. The plurality of developing units 432 include a cyan developing unit, a magenta developing unit, a yellow developing unit, and a black developing unit. The plurality of developing units 432 may include developing units for decolorable toner. When the image forming apparatus 1 is an apparatus for forming an image on a medium in a single color, the image forming unit 43 is configured to include one developing unit 432 instead of a plurality of developing units.

Each developing unit 432 includes a photoconductor drum. Each developing unit 432 includes a charger, a developing device, a primary transfer roller, a cleaning unit (cleaner), a destaticizer, and the like around the photoconductor drum.

The photoconductor drum is an image carrier having a photoconductor layer on a surface thereof. The photoconductor drum rotates about the axis.

The charger uniformly charges the photoconductor layer on the surface of the photoconductor drum. For example, the charger charges the surface of the photoconductor drum to be in the negative polarity.

The developing device develops an electrostatic latent image on the surface of the photoconductor drum using the toner supplied from the toner cartridge 431. That is, the developing device makes the toner adhere to the electrostatic latent image of the photoconductor drum and forms the toner image on the surface of the photoconductor drum.

The primary transfer roller is located at a position facing the photoconductor drum with the intermediate transfer belt 434 interposed therebetween. The primary transfer roller transfers the toner image on the surface of the photoconductor drum to the surface of the intermediate transfer belt 434. The transfer of the toner image from the photoconductor drum to the intermediate transfer belt 434 by the primary transfer roller is also referred to as primary transfer.

The cleaning unit is located at a subsequent stage of the position where the toner image on the surface of the photoconductor drum is transferred to the surface of the intermediate transfer belt 434. The cleaning unit scrapes off untransferred toner and the like to the intermediate transfer belt 434 on the surface of the photoconductor drum.

The destaticizer is located at a position facing the photoconductor drum that passes through the cleaning unit. The destaticizer irradiates the surface of the photoconductor drum with light to destaticize the photoconductor layer of the photoconductor drum. The charges on the photoconductor layer of the photoconductor drum are made uniform.

Each of the plurality of exposure devices 433 is an element that forms an electrostatic latent image on the surface of the photoconductor drum of each developing unit 432. Each exposure device 433 is located at a position facing each developing unit 432. Each exposure device 433 includes a semiconductor laser light source. Each exposure device 433 irradiates the surface of the photoconductor drum of each developing unit 432 with laser light via an optical system such as a polygon mirror. Each exposure device 433 forms an electrostatic pattern as an electrostatic latent image at a position on the surface of the photoconductor drum irradiated with laser light. Each exposure device 433 may include a light emitting diode (LED) instead of the laser light source. When the image forming apparatus 1 is an apparatus for forming an image on a medium in a single color, the image forming unit 43 is configured to include one exposure device 433 instead of a plurality of exposure devices.

The intermediate transfer belt 434 (e.g., an intermediate transfer element) is an endless belt. The intermediate transfer belt 434 can be rotated by action of a roller. The intermediate transfer belt 434 passes between the photoconductor drum of each developing unit 432 and the primary transfer roller.

The transfer unit 435 is an element that transfers a charged toner image on the surface of the intermediate transfer belt 434 to a medium. The transfer of the toner image from the intermediate transfer belt 434 to the medium by the transfer unit 435 is also referred to as secondary transfer. The transfer unit 435 includes a support roller and a secondary transfer roller that face each other. The support roller and the secondary transfer roller are configured to pinch the intermediate transfer belt 434 and the medium from both sides in the thickness direction. The support roller is also a roller that drives the intermediate transfer belt 434.

The fixing unit 44 is a fixing device that heats and pressurizes the medium on which the toner image is transferred to fix the toner image on the medium. The fixing unit 44 includes a heat roller and a pressurizing roller facing each other. The heat roller is a roller provided with a heat source. For example, the heat source is a heater. The heat roller heats the medium on which the toner image is transferred. The pressurizing roller pressurizes the medium on which the toner image passing between the pressurizing roller and the heat roller is transferred.

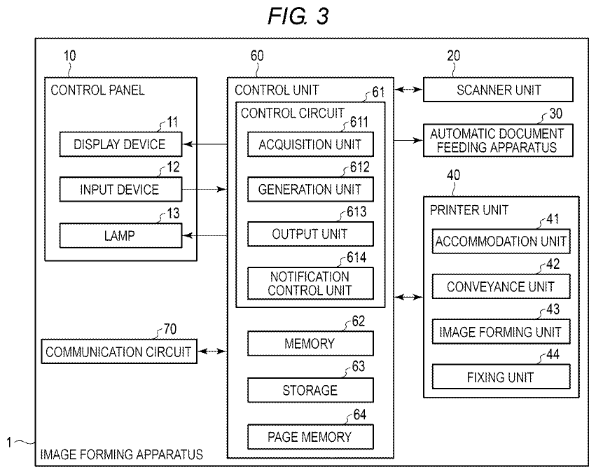

FIG. 3 is a block diagram illustrating an outline of a configuration example of the image forming apparatus 1. The image forming apparatus 1 includes a control unit 60 (e.g., a controller) and a communication circuit 70 in addition to the control panel 10, the scanner unit 20, the automatic document feeding apparatus 30, and the printer unit 40 described above.

The control panel 10 includes a display device 11, an input device 12, and a lamp 13 (e.g., a light source). The display device 11 is a liquid crystal display, an organic electroluminescence (EL) display, or the like. The display device 11 displays information such as a status of the image forming apparatus 1 and various settings. The display device 11 displays options and the like for changing the settings and the like of the image forming apparatus 1. The display device 11 is an example of a display unit. The input device 12 is a touch panel, a hardware key, or the like. The touch panel is configured by stacking the display device 11 and an input device 12. The input device 12 acquires an instruction of the operator. The input device 12 is an example of an input unit. The lamp 13 is a lamp that lights up in various colors according to the control of a notification control unit 614.

The control unit 60 is configured as a computer that controls the operation of each part of the image forming apparatus 1. The control unit 60 includes a control circuit 61, a memory 62, a storage 63, and a page memory 64.

The control circuit 61 corresponds to a central part of a computer. For example, the control circuit 61 is a circuit including a processor such as a central processing unit (CPU). The control circuit 61 may include an application specific integrated circuit (ASIC), a field programmable gate array (FPGA), a graphics processing unit (GPU), or the like in addition to or in place of the CPU. The control circuit 61 loads the program stored in the storage 63 or the like into the memory 62. The control circuit 61 executes various operations by executing the program loaded into the memory 62. The program is a program that realizes each part described later in the control circuit 61.

The memory 62 includes a read only memory (ROM) and a random access memory (RAM). The ROM corresponds to a main memory of a computer including the control circuit 61 as a central part. The ROM is a non-volatile memory. The ROM stores data or various set values used for performing various pieces of processing by the control circuit 61. The RAM corresponds to the main memory of the computer including the control circuit 61 as a central part. The RAM is a memory used for reading and writing data. The RAM is a so-called work area where data temporarily used for performing various pieces of processing by the control circuit 61 is stored.

The storage 63 corresponds to an auxiliary storage device of the computer including the control circuit 61 as a central part. For example, the storage 63 is an electric erasable programmable read-only memory (EEPROM) (registered trademark), a hard disk drive (HDD), a solid state drive (SSD), or the like. The storage 63 stores the program described above. The storage 63 stores data used for performing various pieces of processing by the control circuit 61. The storage 63 can also record image data to be printed. The storage 63 is an example of a storing unit.

The page memory 64 is a memory having a storage area for loading image data for at least one page. The image data is transferred from the page memory 64 to the storage 63.

The communication circuit 70 is an interface that enables the image forming apparatus 1 to communicate with another apparatus via the network 2. The communication circuit 70 is an example of a communication interface. The communication circuit 70 is an example of a communication unit.

Next, each part installed on the control circuit 61 will be described. On the control circuit 61, an acquisition unit 611, a generation unit 612, an output unit 613, and the notification control unit 614 are installed. Each part installed on the control circuit 61 can also be considered to be each function. Each part installed in the control circuit 61 can be considered to be installed in the control unit 60 including the control circuit 61 and the memory 62.

The acquisition unit 611 acquires abnormality prediction information from an abnormality prediction program. The abnormality prediction program is, for example, a program that executes an abnormality prediction process according to a diagnostic algorithm correlated with an apparatus function of the image forming apparatus 1. The abnormality prediction process is, for example, a process of calculating an abnormal situation of the apparatus function expected to occur in the future according to a diagnostic algorithm. The abnormality prediction information is information generated by the abnormality prediction process of the abnormality prediction program. The abnormality prediction information is information indicating the abnormal situation (e.g., describing a predicted abnormality in operation of the image forming apparatus 1) such as a type of abnormality of apparatus function expected to occur in the future, an expected time until the abnormality is predicted to occur (e.g., a timing when the abnormality if predicted to occur), a probability of occurrence of abnormality, and the like in the image forming apparatus 1.

The diagnostic algorithm is an algorithm that determines the presence or absence of an abnormality that is expected to occur in a component or the like of the image forming apparatus 1 in the future, based on the diagnosis of operation log data of the image forming apparatus 1. The operation log data includes error data, data related to the apparatus function of the image forming apparatus 1 such as a counter, and the like. The type of abnormality of apparatus function includes, for example, a print jam, an ADF jam, a platen abnormality, a paper size error, a network error, and the like. The expected time until abnormality includes, for example, information such as “immediate occurrence”, “occurrence within 1 day”, and “occurrence within 1 week”. The probability of occurrence of abnormality includes, for example, information such as “90% or more” and “80% or more”. The abnormality prediction process by the abnormality prediction program can be executed using a known abnormality prediction technique. Prediction includes the meaning of expectation. The abnormality includes not only hardware failures, but also software errors.

The acquisition unit 611 may acquire the abnormality prediction information from the abnormality prediction program stored in the storage 63. The acquisition unit 611 may acquire the abnormality prediction information from the abnormality prediction program stored in a cloud. The abnormality prediction program can be appropriately updated. The abnormality prediction program may be stored in the image forming apparatus 1 and the cloud. In this case, the abnormality prediction program stored in the cloud may be updated in synchronization with the update of the abnormality prediction program stored in the image forming apparatus 1.

The generation unit 612 generates equipment information based on the abnormality prediction information. Generating may include updating (e.g., updating previously generated information). The equipment information includes identification information, an address, and a location of each image forming apparatus 1. The identification information is unique identification information assigned to each image forming apparatus. The identification information is, for example, an equipment name of the image forming apparatus 1. The address is, for example, an IP address or MAC address of the image forming apparatus 1. The location is information indicating a place where the image forming apparatus 1 is installed. The location is, for example, “10th floor A section (10F-A)” or the like. The identification information, the address, and the location are information that specifies each image forming apparatus 1.

The equipment information includes information about the abnormality. The information about the abnormality is information indicating an abnormality degree of the image forming apparatus 1 generated based on the abnormality prediction information. The abnormality degree is the degree of abnormality in the current apparatus function of the image forming apparatus 1 derived based on the type of abnormality, the expected time until abnormality, and the probability of occurrence of abnormality. The information about the abnormality includes, for example, “abnormality”, “warning”, “notification”, and the like according to the abnormality degree. The information about the abnormality includes, for example, “occurs immediately”, “occurs within 1 day”, “occurs within 1 week”, and the like, according to the abnormality degree.

The equipment information includes information about a usable function. Information about a usable function is information indicating the currently usable function of the image forming apparatus 1 generated based on the abnormality prediction information. The information indicating the usable function, for example, “data transfer possible”, “platen usable”, “ADF usable”, and the like. “Data transfer possible” indicates that data can be transferred from the image forming apparatus 1 to a server or cloud (not illustrated). For example, a user transmits print data to the image forming apparatus 1 which is in “data transfer possible”, and can utilize a print function based on the transferred data by using another image forming apparatus 1-1 or the like. Another image forming apparatus 1-1 is any image forming apparatus included in a plurality of image forming apparatuses 1. The “platen usable” indicates that a copy function or scan function using the platen can be utilized. The “ADF usable” indicates that the copy function or scan function using the ADF can be utilized.

The equipment information includes information about another image forming apparatus. The information about another image forming apparatus is information generated based on the equipment information acquired from another image forming apparatus 1-1 different from the image forming apparatus 1. The information about another image forming apparatus is, for example, information indicating that another image forming apparatus 1-1 is usable. The information about another image forming apparatus includes, for example, “another printer recommendation”. “Another printer recommendation” indicates that another image forming apparatus 1-1 can be used and the use of another forming apparatus 1-1 is recommended as compared with the image forming apparatus 1 in relation to the abnormality degree. The generation unit 612 may generate information about another image forming apparatus indicating “another printer recommendation” only in an emergency based on the abnormality prediction information of the image forming apparatus 1.

The equipment information includes information about (e.g., regarding, related to) a maintenance request. The information about the maintenance request is information about a maintenance request notification provided by the notification control unit 614. The information about the maintenance request notification is information indicating a content of the maintenance request notification. The maintenance request notification is a notification for requesting the maintenance generated by the notification control unit 614 based on the abnormality prediction information. The maintenance request notification is output to the administrator terminal 3 via the network 2 by the notification control unit 614. The maintenance request notification may be output to the management server by the notification control unit 614. The information about the maintenance request includes, for example, “maintenance is being arranged”, “maintenance request within 1 day”, “maintenance request within 2 to 3 days”, and the like.

The output unit 613 outputs the equipment information to the user terminal 4 via the router 5. The output unit 613 changes an output timing for outputting the equipment information to the user terminal 4 based on the abnormality prediction information. The output unit 613 changes the necessity of outputting (e.g., determines whether or not to output) the equipment information to the user terminal 4 based on the abnormality prediction information. Outputting includes the meaning of transmitting.

The notification control unit 614 controls a notification related to abnormality based on the abnormality prediction information. The notification related to abnormality includes, for example, a maintenance request notification, lighting of the lamp 13, display of equipment information on the display device 11, and the like. The notification control unit 614 selectively controls the notification related to abnormality according to, for example, an abnormal situation.

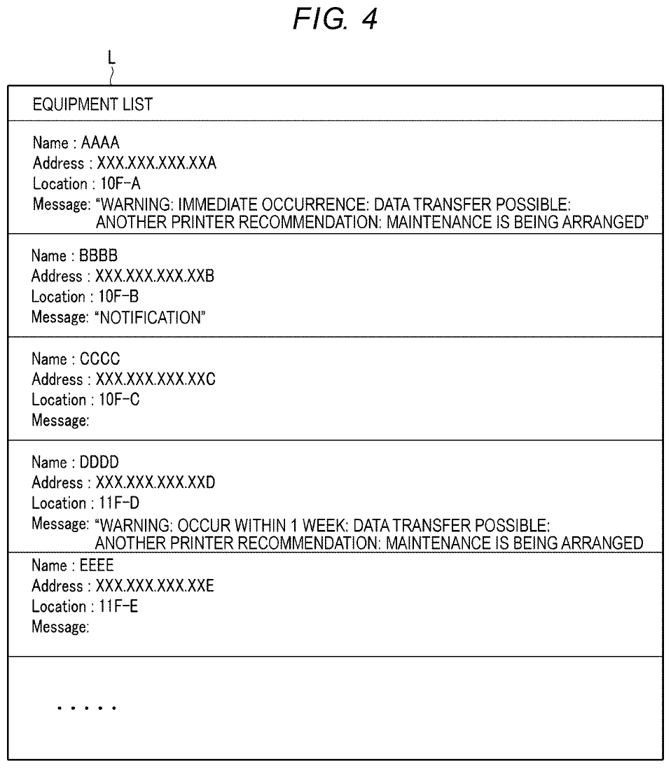

Next, an example of a screen displayed on the user terminal 4 will be described. FIG. 4 is a diagram illustrating an example of an equipment list L displayed on the user terminal 4 according to the embodiment.

The equipment list L is generated based on the equipment information acquired from at least one image forming apparatus 1. The equipment list L is generated based on the equipment information when the user of the user terminal 4 starts the application correlated with the image forming apparatus 1. The equipment list L lists and displays equipment information of at least one usable image forming apparatus 1. The equipment information displayed in the equipment list L includes an equipment name, an address, a location, and a message. The message corresponds to at least one of information about the abnormality, information about usable function, information about another image forming apparatus, and information about maintenance request.

Hereinafter, the equipment information displayed in the equipment list L for the image forming apparatus 1 having an equipment name “AAAA” will be described with reference to FIG. 4. The equipment information of the image forming apparatus “AAAA” includes the identification information “AAAA”, the address “XXX.XXX.XXX.XXA”, and the location “10th floor A section”. The equipment information of the image forming apparatus “AAAA” includes the message “Warning: Immediate occurrence: Data transfer possible: Another printer recommendation: Maintenance is being arranged”. Respective items configuring the message correspond to messages A to E described later.

According to this example, the user terminal 4 displays information specifying each image forming apparatus 1 and a message generated based on the abnormality prediction information. For that reason, the user terminal 4 can visualize a state of each image forming apparatus 1. The user of the user terminal 4 can appropriately select the image forming apparatus 1 according to the function to be utilized based on the displayed information.

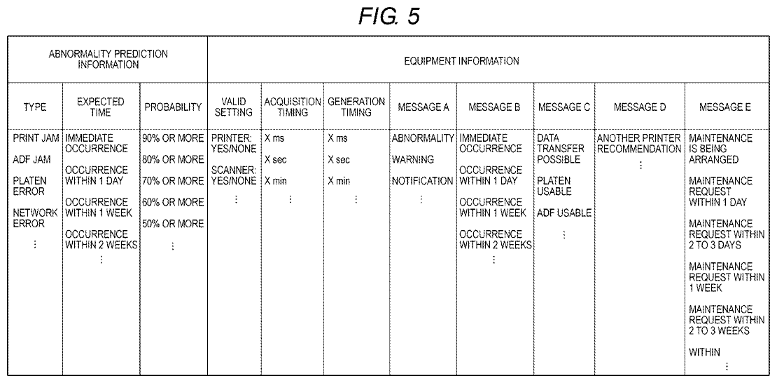

Next, an example of abnormality prediction information and equipment information will be described. FIG. 5 is a diagram illustrating abnormality prediction information and equipment information in the image forming apparatus 1 according to the embodiment. As illustrated in the figure, the abnormality prediction information includes items of “type of abnormality”, “expected time until abnormality”, and “probability of occurrence of abnormality” indicating the abnormal situation. Each item includes a plurality of selectable values. The value can be a numerical value or a text value. Each item corresponds to the item of abnormality prediction information acquired from the abnormality prediction program.

The equipment information includes the items of “validity setting”, “acquisition timing”, “generation timing”, “message A”, “message B”, “message C”, “message D”, and “message E”. Each item includes a plurality of selectable values. The value may be a numerical value or a text value. The value may include any display mode such as an icon and a symbol.

The “validity setting” or “valid setting” is information indicating a setting of whether or not the image forming apparatus 1 outputs equipment information. The setting of whether or not to output the equipment information is a setting of valid (“Yes” illustrated in FIG. 5) or invalid (“None” illustrated in FIG. 5). The “validity setting” can be changed based on the abnormality prediction information acquired from the abnormality prediction program. The “validity setting” can be set according to the abnormal situation of the apparatus function of the image forming apparatus 1 based on the abnormality prediction information. For example, when the probability of occurrence of abnormality in the image forming apparatus 1 is higher than a threshold value, the “validity setting” may be set to invalid. The “validity setting” may be decided based on at least one of the items “type of abnormality”, “expected time until abnormality”, and “probability of occurrence of abnormality” included in the abnormality prediction information. The “validity setting” may be determined based on any combination of the items “type of abnormality”, “expected time until abnormality”, and “probability of occurrence of abnormality” included in the abnormality prediction information. The “validity setting” may be updated every time the abnormality prediction information is acquired, or the same value may be set for a fixed period of time. The “validity setting” may be set in advance by the image forming apparatus 1, or may be updated as appropriate by the administrator.

The “acquisition timing” is information indicating the acquisition timing for acquiring the abnormality prediction information from the abnormality prediction program. The acquisition timing is set, for example, based on the abnormality prediction information, according to the abnormal situation of the apparatus function of the image forming apparatus 1. For example, when the probability of occurrence of abnormality in the image forming apparatus 1 is higher than the threshold value, an interval of acquisition timing may be shortened, and when the probability of occurrence of abnormality is equal to or less than the threshold value, the interval of acquisition timing may be lengthened. The acquisition timing may be decided based on at least one of the items “type of abnormality”, “expected time until abnormality”, and “probability of occurrence of abnormality” included in the abnormality prediction information. The acquisition timing may be decided based on any combination of the items of “type of abnormality”, “expected time until abnormality”, and “probability of occurrence of abnormality” included in the abnormality prediction information. The acquisition timing may be updated every time the abnormality prediction information is acquired, or the same value may be set for a fixed period of time.

The “generation timing” is information indicating the generation timing for generating equipment information based on the abnormality prediction information acquired from the abnormality prediction program. The generation timing may be decided similarly to the acquisition timing. As the generation timing, the same timing as the acquisition timing may be set. The generation timing may be updated every time the abnormality prediction information is acquired, or the same value may be set for a fixed period of time.

The “message A” and “message B” correspond to information about the abnormality. The “message A” includes “abnormality”, “warning”, “notification”, and the like indicating the abnormal situation. The “message A” is set according to the abnormal situation of the apparatus function of the image forming apparatus 1, based on the abnormality prediction information. For example, when the probability of occurrence of abnormality in the image forming apparatus 1 is higher than the first threshold value, the “message A” may indicate the “abnormality”. When the probability of occurrence of abnormality is equal to or lower than the first threshold value and higher than a second threshold value, the “message A” may indicate the “warning”. When the probability of occurrence of abnormality is equal to or less than the second threshold value, the “message A” may indicate the “notification”. The “message A” may be decided based on at least one of the items “type of abnormality”, “expected time until abnormality”, and “probability of occurrence of abnormality” included in the abnormality prediction information. The “message A” may be decided based on any combination of the items “type of abnormality”, “expected time until abnormality”, and “probability of occurrence of abnormality” included in the abnormality prediction information. The “message A” may be updated every time the abnormality prediction information is acquired, or the same value may be set for a fixed period of time. In this example, “message A” is described as having a three-stage abnormality degree of the “abnormality”, the “warning”, and the “notification”, but is not limited thereto. The “message A” may be display by which the abnormality degree can be identified.

The “message B” is set based on the “expected time until abnormality” included in the abnormality prediction information. For example, the “message B” is set as a value corresponding to the “expected time until abnormality” based on the abnormality prediction information. The “message B” may be updated every time the abnormality prediction information is acquired, or the same value may be set for a fixed period of time.

The “message C” corresponds to the information about usable function. The “message C” is set based on the “type of abnormality” included in the abnormality prediction information. For example, when the “abnormality type” indicates “print jam”, the “message C” may indicate “data transfer possible”. The “message C” may be decided based on at least one of the “expected time until abnormality” and “probability of occurrence of abnormality”, in addition to the item of “type of abnormality”. The “message C” may be updated every time the abnormality prediction information is acquired, or the same value may be set for a fixed period of time.

The “message D” corresponds to the information about another image forming apparatus. The “message D” is set based on the equipment information acquired from another image forming apparatus 1-1 and the abnormality prediction information about the image forming apparatus 1. The “message D” is set according to the equipment information of another image forming apparatus 1-1 and the abnormal situation of the apparatus function of the image forming apparatus 1. The equipment information of another image forming apparatus 1-1 is also referred to as other equipment information. The “message D” may be decided based on at least one of the items of “type of abnormality”, “expected time until abnormality”, and “probability of occurrence of abnormality”, in addition to other equipment information. The “message D” may be decided based on any combination of the items of “type of abnormality”, “expected time until abnormality”, and “probability of occurrence of abnormality”, in addition to other equipment information. For example, when the probability of occurrence of abnormality in the image forming apparatus 1 is higher than the threshold value and another image forming apparatus 1-1 is usable, the “message D” may indicate “another printer recommendation”.

Furthermore, the “message D” may be set by comparing other equipment information with the abnormal situation of the apparatus function of the image forming apparatus 1. For example, it is assumed that the type of abnormality of the image forming apparatus 1 is “out of A4 paper”, and that another image forming apparatus 1-1 has no abnormality in the A4 paper tray from the equipment information. In this case, the “message D” may indicate “another printer recommendation” indicating that another image forming apparatus 1-1 is recommended. The “message D” may additionally include a message about a function, such as “A4 paper is usable”, that is recommended for use in another image forming apparatus 1-1 than the image forming apparatus 1. The “message D” may be updated every time the abnormality prediction information is acquired, or the same value may be set for a fixed period of time.

The “message E” corresponds to the information about maintenance request. The “message E” is set based on the maintenance request notification generated by the notification control unit 614. For example, the “message E” includes the “maintenance is being arranged”, the “maintenance request within 1 day”, the “maintenance request within 2 to 3 days”, and the like. The “message E” may be updated every time the abnormality prediction information is acquired, or the same value may be set for a fixed period of time.

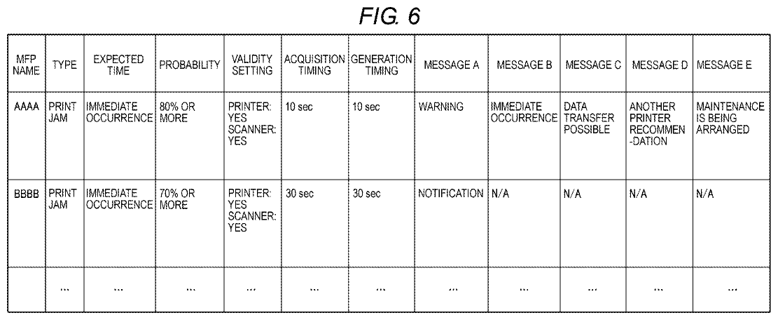

FIG. 6 is a diagram illustrating an example of a combination of abnormality prediction information and equipment information in the image forming apparatus 1.

Each image forming apparatus 1 generates equipment information based on the acquired abnormality prediction information. The equipment information includes a value selected from a plurality of values illustrated in FIG. 5. FIG. 6 illustrates an example of the combination of abnormality prediction information and equipment information for the image forming apparatus 1 having the equipment name “AAAA” and the image forming apparatus 1 having the equipment name “BBBB”. In FIG. 6, “N/A” is illustrated for the items of equipment information that do not have a corresponding value. The items of equipment information that do not have the corresponding value are not displayed in the equipment list L.

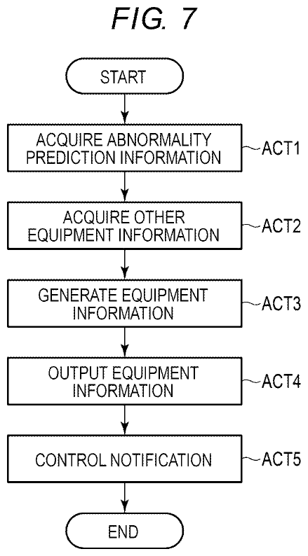

Next, a processing procedure for generating equipment information in the image forming apparatus 1 will be described. FIG. 7 is a flowchart illustrating the processing procedure for generating equipment information in the image forming apparatus 1 according to the embodiment.

The processing procedure described below is only an example, and each process may be changed as much as possible. Further, with respect to the processing procedure described below, steps can be omitted, replaced, and added as appropriate according to the embodiment.

The image forming apparatus 1 starts a processing procedure described below when acquiring the abnormality prediction information. The timing for starting an equipment information generation process is not limited thereto. For example, the image forming apparatus 1 may start the equipment information generation process in response to an equipment information generation instruction for generating the equipment information from the administrator terminal 3. In the following, “in response to” may be read as “based on”.

The acquisition unit 611 acquires the abnormality prediction information of the image forming apparatus 1 (ACT 1). In ACT 1, for example, the acquisition unit 611 acquires the abnormality prediction information of the image forming apparatus 1 from the abnormality prediction program stored in the storage 63. The acquisition unit 611 acquires the abnormality prediction information of the image forming apparatus 1 from the abnormality prediction program according to the interval of the acquisition timing. The acquisition unit 611 may change the acquisition timing for acquiring the abnormality prediction information based on the abnormality prediction information.

The acquisition unit 611 acquires other equipment information output from another image forming apparatus 1-1 (ACT 2). In ACT 2, for example, the acquisition unit 611 acquires other equipment information via the network 2. The acquisition unit 611 acquires other equipment information intermittently output from another image forming apparatus 1-1.

The generation unit 612 generates equipment information based on the abnormality prediction information acquired by the acquisition unit 611 (ACT 3). In ACT 3, for example, the generation unit 612 changes the necessity of adding the information about the abnormality to the equipment information based on the abnormality prediction information. The generation unit 612 determines the necessity of adding the information about the abnormality to the equipment information based on the abnormal situation included in the abnormality prediction information. The generation unit 612 may make a determination based on at least one of the type of abnormality, the expected time until the abnormality is predicted to occur, the probability of occurrence of the abnormality, or any combination thereof. When it is determined that addition of the information about the abnormality to the equipment information needs to be added, the generation unit 612 adds the information about the abnormality to the equipment information.

The generation unit 612 determines the necessity of changing the information about the abnormality based on the abnormal situation included in the abnormality prediction information. The generation unit 612 may make a determination based on at least one of the type of abnormality, the expected time until the abnormality is predicted to occur, the probability of occurrence of the abnormality, or any combination thereof. When it is determined that the information about the abnormality needs to be changed, the generation unit 612 changes the information about the abnormality to be added to the equipment information.

According to this example, the generation unit 612 can add the information about the abnormality to the equipment information or change the information about the abnormality according to the abnormal situation. For that reason, the generation unit 612 can generate the equipment information of the image forming apparatus 1 based on the abnormal situation. The user terminal 4 can visualize the information about the abnormality of the image forming apparatus 1 based on the received equipment information. For that reason, the user can easily recognize the information about the abnormality of the image forming apparatus 1.

In another example, the generation unit 612 changes the necessity of adding the information about a usable function of the image forming apparatus 1 based on the abnormality prediction information. The generation unit 612 determines the necessity of adding the information about the usable function to the equipment information, based on the abnormal situation included in the abnormality prediction information. The generation unit 612 may make a determination based on at least one of the type of abnormality, the expected time until the abnormality is predicted to occur, the probability of occurrence of abnormality, or any combination thereof. When it is determined that the information about the usable function needs to be added to the equipment information, the generation unit 612 adds information about the usable function to the equipment information.

The generation unit 612 determines the necessity of changing the information about the usable function based on the abnormal situation included in the abnormality prediction information. The generation unit 612 may make a determination based on at least one of the type of abnormality, the expected time until abnormality, the probability of occurrence of abnormality, or any combination thereof. When it is determined that the information about the usable function needs to be changed, the generation unit 612 changes the information about the usable function to be added to the equipment information.

According to this example, the generation unit 612 can add the information about the usable function to the equipment information or change the information about the usable function to be added thereto, according to the abnormal situation. For that reason, the generation unit 612 can generate the equipment information of the image forming apparatus 1 based on the abnormal situation. The user terminal 4 can visualize the information about the usable function of the image forming apparatus 1 based on the received equipment information. For that reason, the user can easily recognize the information about the usable function of the image forming apparatus 1.

In still another example, the generation unit 612 changes the necessity of adding (e.g., determines whether or not to add) information about another image forming apparatus to the equipment information of the image forming apparatus 1 based on the abnormality prediction information and the other equipment information. The generation unit 612 determines the necessity of adding the information about another image forming apparatus to the equipment information based on the abnormal situation included in the abnormality prediction information. The generation unit 612 may make a determination based on at least one of the type of abnormality, the expected time until the abnormality is predicted to occur, the probability of occurrence of abnormality, or any combination thereof. When it is determined that the information about another image forming apparatus needs to be added to the equipment information, the generation unit 612 adds the information about another image forming apparatus to the equipment information.

The generation unit 612 determines the necessity of changing (e.g., determines whether or not to change) the information about another image forming apparatus based on the abnormal situation included in the abnormality prediction information. The generation unit 612 may make a determination based on at least one of the type of abnormality, the expected time until abnormality, the probability of occurrence of abnormality, or any combination thereof. When it is determined that the information about another image forming apparatus needs to be changed, the generation unit 612 changes the information about another image forming apparatus to be added to the equipment information.

According to this example, the generation unit 612 can add the information about another image forming apparatus to the equipment information or change the information about another image forming apparatus to be added thereto according to the abnormal situation. For that reason, the generation unit 612 can generate the equipment information of the image forming apparatus 1 based on the abnormal situation. The user terminal 4 can visualize the information about another image forming apparatus of the image forming apparatus 1 based on the received equipment information. For that reason, the user can easily recognize the information about another image forming apparatus of the image forming apparatus 1.

The generation unit 612 changes the generation timing for generating equipment information according to the acquisition timing. The generation timing may be the same as the acquisition timing, or may be decided as a timing different from the acquisition timing based on the abnormality prediction information.

According to this example, the generation unit 612 can change the generation timing for generating the equipment information according to the abnormal situation. For that reason, when the degree of abnormality is high and the time until the abnormality occurs is short, the generation unit 612 can generate the equipment information with high frequency. The image forming apparatus 1 can provide more appropriate equipment information to the user terminal 4. For that reason, the image forming apparatus 1 can improve the convenience of the user.

The generation unit 612 may change the necessity of generating (e.g., determine whether or not to generate) the equipment information based on the abnormality prediction information. For example, the generation unit 612 changes the necessity of generating the equipment information based on the abnormal situation included in the abnormality prediction information. The generation unit 612 may change the necessity of generating equipment information based on at least one of the type of abnormality, the expected time until abnormality, and the probability of occurrence of abnormality, or any combination thereof. For example, when the probability of occurrence of abnormality is higher than the threshold value, the generation unit 612 omits the generation of equipment information. When the generation of the equipment information is omitted, the generation unit 612 sets the content of “validity setting” to invalid in order to omit the output of the equipment information.

According to this example, the generation unit 612 can change the necessity of generating the equipment information according to the abnormal situation. For that reason, the generation unit 612 can simplify the equipment information generation process based on the abnormal situation. The equipment information of the image forming apparatus 1 which has a high degree of abnormality and is not suitable for use is not generated by the generation unit 612. Since the image forming apparatus 1 does not output the equipment information of the image forming apparatus 1 unsuitable for use to the user terminal 4, the convenience of the user can be improved.

The output unit 613 outputs the equipment information generated by the generation unit 612 (ACT 4). In ACT 4, for example, the output unit 613 outputs the equipment information to the user terminal 4 via the router 5. The communication circuit 70 outputs the equipment information to the user terminal 4 under the control of the output unit 613.

According to this example, the output unit 613 can output the equipment information of the image forming apparatus 1 based on the abnormality prediction information to the user terminal 4. The output unit 613 can provide the user terminal 4 with the equipment information of the image forming apparatus 1 reflecting the abnormality prediction information that may change with the passage of time. For that reason, the image forming apparatus 1 can improve the convenience of the user.

The output unit 613 may change the output timing for outputting the equipment information based on the abnormality prediction information. For example, the output unit 613 changes the output timing according to the generation timing. The output timing may be the same as the generation timing, or may be decided as a timing different from the generation timing based on the abnormality prediction information.

According to this example, the output unit 613 can change the output timing for outputting the equipment information according to the abnormal situation. For that reason, when the degree of abnormality is high and the time until abnormality occurs is short, the output unit 613 can output equipment information with high frequency. Since the user terminal 4 can receive updated equipment information at an appropriate frequency, more appropriate equipment information can be provided to the user. For that reason, the image forming apparatus 1 can improve the convenience of the user.

The output unit 613 may change the necessity of outputting (e.g., determine whether or not to output) the equipment information based on the abnormality prediction information. For example, the output unit 613 changes the necessity of outputting equipment information based on the “validity setting”. The necessity of outputting the equipment information can be linked to the necessity of generating the equipment information by the generation unit 612.

According to this example, the output unit 613 can change the necessity of outputting the equipment information according to the abnormal situation. For that reason, the output unit 613 can simplify processing for outputting the equipment information based on the abnormal situation. The equipment information of the image forming apparatus 1 which has a high degree of abnormality and is not suitable for use is not output by the output unit 613. Since the output unit 613 does not output the equipment information of the image forming apparatus 1 unsuitable for use to the user terminal 4, the image forming apparatus 1 can improve the convenience of the user.

The notification control unit 614 controls the notification related to abnormality in the image forming apparatus 1 based on the abnormality prediction information (ACT 5). In ACT 5, for example, the notification control unit 614 controls the notification related to abnormality based on the abnormal situation included in the abnormality prediction information. The notification control unit 614 may control the notification related to abnormality based on at least one of the type of abnormality, the expected time until abnormality, the probability of occurrence of abnormality, or any combination thereof. The notification control unit 614 controls necessity and change of maintenance request notification, lighting of the lamp 13, and display of equipment information on the display device 11. The notification control unit 614 controls at least one of the maintenance request notification, the lighting of the lamp 13, and the display of equipment information on the display device 11.

In one example, the notification control unit 614 outputs the maintenance request notification to the administrator terminal 3 according to the abnormal situation of the apparatus function of the image forming apparatus 1 via the network 2. The communication circuit 70 outputs the maintenance request notification to the administrator terminal 3 under the control of the notification control unit 614. For example, when the probability of occurrence of abnormality is higher than the threshold value, the notification control unit 614 outputs the notification requesting maintenance. When the probability of occurrence of abnormality is equal to or less than the threshold value, the notification control unit 614 suspends the maintenance request. The notification control unit 614 may decide a period of time for suspending the maintenance request according to the abnormal situation. In this case, the generation unit 612 changes the necessity of adding (e.g., determines whether or not to add) the maintenance request information to the equipment information in response to the output of the maintenance request notification by the notification control unit 614. Alternatively, the generation unit 612 changes the information about maintenance request to the equipment information in response to the output of the maintenance request notification by the notification control unit 614.

According to this example, the notification control unit 614 can output the maintenance request notification according to the abnormal situation. For that reason, the administrator can request maintenance at an appropriate timing. The notification control unit 614 can display a maintenance request situation on the display device 11. For that reason, the user can easily recognize the maintenance request status of the image forming apparatus 1 in which the abnormality occurs. The notification control unit 614 can control the maintenance request notification based on processing of equipment information. For that reason, the image forming apparatus 1 can simplify processing for notifying the maintenance request notification.

In another example, the notification control unit 614 controls the necessity of lighting the lamp 13 according to the abnormal situation. The lamp 13 is lit in a different mode according to the abnormal situation under the control of the notification control unit 614. For example, when the probability of occurrence of abnormality is higher than the first threshold value, the notification control unit 614 may light the lamp 13 in red. When the probability of occurrence of abnormality is equal to or less than the first threshold value and higher than the second threshold value, the notification control unit 614 may light the lamp 13 in yellow. When the probability of occurrence of abnormality is equal to or less than the second threshold value, the notification control unit 614 may light the lamp 13 in blue. In this example, the notification control unit 614 is described as controlling the lamp 13 in three stages of red, yellow, and blue, but is not limited thereto. The notification control unit 614 may control lighting of the lamp 13 in a mode capable of identifying the abnormal situation.

According to this example, the notification control unit 614 can control the lamp 13 according to the abnormal situation. For that reason, the user can easily specify the image forming apparatus 1 in which the abnormality occurs. The notification control unit 614 can control lighting of the lamp 13 based on processing of equipment information. For that reason, the image forming apparatus 1 can simplify processing for controlling the lamp 13.

In still another example, the notification control unit 614 controls the necessity of displaying (e.g., determines whether or not to display) of the display device 11 according to the abnormal situation. The display device 11 displays a message indicating equipment information in accordance with the abnormal situation under the control of the notification control unit 614. For example, when the probability of occurrence of abnormality is higher than the threshold value, the notification control unit 614 may cause the display device 11 to display a message similar to the message included in the equipment information. The notification control unit 614 may cause the display device 11 to display the message in a mode different from the message included in the equipment information. The notification control unit 614 may cause the display device 11 to display the message as a moving image by using moving image data. Alternatively, the notification control unit 614 may output a message by voice by using voice data.

According to this example, the notification control unit 614 can cause the display device 11 to display the message indicating equipment information in accordance with the abnormal situation. For that reason, the user can easily specify the image forming apparatus 1 in which the abnormality occurs, and can easily recognize the equipment information even when the image forming apparatus 1 is actually utilized. The notification control unit 614 can control the display of the display device 11 based on processing of equipment information. For that reason, the image forming apparatus 1 can simplify processing for controlling display.

In this embodiment, processing in which the image forming apparatus 1 communicates with the user terminal 4 via the network 2 is illustratively described, but is not limited thereto. The image forming apparatus 1 may communicate with the user terminal 4 by executing short-range wireless communication in which pieces of equipment directly communicate with each other. For example, short-range wireless communication includes Bluetooth (registered trademark), Bluetooth Low Energy (BLE) communication, and the like. The communication between the image forming apparatus 1 and the user terminal 4 may be Wi-Fi (registered trademark) or the like.

The information processing apparatus may be realized by one apparatus as described by taking the image forming apparatus 1 as an example, or may be realized by a system in which the functions are distributed to a plurality of apparatuses.

The information processing apparatus is not limited to the image forming apparatus 1, and can be applied to various apparatuses.

The transfer of an apparatus is generally performed in a state where a program is stored in a main memory or an auxiliary storage device. However, the exemplary embodiment is not limited thereto, and the program may be transferred without being stored in the main memory or the auxiliary storage device. In this case, a program transferred separately from the apparatus is written to a writable storage device provided in the apparatus according to an operation by the user or the like. The transfer of the program can be done by recording on a removable recording medium or by communication via a network. The recording medium is a non-transitory tangible medium. The recording medium is a computer-readable medium. The recording medium may be in any form as long as the recording medium, such as a CD-ROM or a memory card, can store a program and the apparatus can read the recording medium. A function obtained by installing or downloading the program may be one that realizes the function in cooperation with an operating system (OS) or the like inside the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a controller configured to:
acquire abnormality prediction information relating to a predicted abnormality concerning operation of the information processing apparatus;
generate equipment information based on the abnormality prediction information; and
output the equipment information generated by the controller.

2. The information processing apparatus of claim 1, wherein:
the controller is further configured to obtain additional abnormality prediction information and generate additional equipment information,
the controller being configured to vary a timing when the controller acquires additional abnormality prediction information based on the abnormality prediction information; and
the controller being configured to vary a timing when the controller outputs additional equipment information based on the abnormality prediction information.

3. The information processing apparatus of claim 1, wherein the controller is configured to determine whether or not to add information describing the predicted abnormality to the equipment information based on the abnormality prediction information.

4. The information processing apparatus of claim 3, wherein the controller is configured to change the information about the predicted abnormality to be added to the equipment information based on the abnormality prediction information.

5. The information processing apparatus of claim 1, wherein the controller is configured to determine whether or not to output the equipment information based on the abnormality prediction information.

6. The information processing apparatus of claim 1, wherein the controller is configured to determine whether or not to add information about a usable function of the information processing apparatus to the equipment information based on the abnormality prediction information.

7. The information processing apparatus of claim 6, wherein the controller is configured to change the information about the usable function of the information processing apparatus based on the abnormality prediction information.

8. The information processing apparatus of claim 1, wherein:
the controller is configured to acquire other equipment information from another information processing apparatus; and
the controller is configured to determine whether or not to add information about the other information processing apparatus to the equipment information based on the abnormality prediction information and the other equipment information.

9. The information processing apparatus of claim 1, wherein the controller is configured to control a notification related to the predicted abnormality based on the abnormality prediction information acquired by the controller.

10. The information processing apparatus of claim 1, wherein the information processing apparatus is an image forming apparatus including a printer configured to form an image on a medium.

11. The information processing apparatus of claim 1, wherein the controller is configured to output the equipment information generated by the controller to a user device that displays the equipment information.

12. The information processing apparatus of claim 1, wherein the abnormality prediction information includes at least one of (a) a type of the predicted abnormality, (b) a timing when the predicted abnormality is predicted to occur, or (c) a probability that the predicted abnormality will occur.

13. The information processing apparatus of claim 12, wherein the abnormality prediction information includes the type of the predicted abnormality.

14. The information processing apparatus of claim 12, wherein the abnormality prediction information includes the timing when the predicted abnormality is predicted to occur.

15. The information processing apparatus of claim 12, wherein the abnormality prediction information includes the probability that the predicted abnormality will occur.

16. The information processing apparatus of claim 1, wherein:
the information processing apparatus is in communication with another information processing apparatus; and
the equipment information includes information about a usable function of the other information processing apparatus.

17. An information processing method comprising:
acquiring, by a controller of an information processing apparatus, abnormality prediction information relating to a predicted abnormality concerning operation of the information processing apparatus;
generating, by the controller, equipment information based on the abnormality prediction information; and
outputting, by the controller, the equipment information.

18. The method of claim 17, further comprising:
determining, by the controller, whether or not to add information about a usable function of the information processing apparatus to the equipment information based on the abnormality prediction information; and
changing, by the controller, the information about the usable function of the information processing apparatus based on the abnormality prediction information.

19. The method of claim 17, further comprising:
acquiring, by the controller, other equipment information from another information processing apparatus; and
determining, by the controller, whether or not to add information about the other information processing apparatus to the equipment information based on the abnormality prediction information and the other equipment information.

20. The method of claim 19, further comprising controlling, by the controller, a notification related to the predicted abnormality based on the abnormality prediction information.
